(19) United States
(12) Patent Application Publication
(10) Pub. No.: US 2025/0043691 A1
(43) Pub. Date: Feb. 6, 2025

(54) GAS TURBINE ENGINE HAVING OPTIMIZED ACCELERATION RATES BASED ON CLEARANCES

(71) Applicant: General Electric Company, Schenectady, NY (US)

(72) Inventor: Timothy Leo Schelfaut, Lebanon, OH (US)

(21) Appl. No.: 18/362,381

(22) Filed: Jul. 31, 2023

(51) Int. Cl. F01D 11/20; F02C 9/00

(52) U.S. Cl. CPC F01D 11/20; F02C 9/00

(57) ABSTRACT

A method of operating a gas turbine engine includes operating the gas turbine engine in a first flight condition. The method further includes receiving a demand for a second flight condition that is different than the first flight condition. The method further includes determining a final target clearance and a transient target clearance between the first component and the second component. The final target clearance is associated with the second flight condition. The method further includes adjusting an engine acceleration rate to a nominal acceleration rate. The method further includes comparing an actual clearance with the transient target clearance after an increment of time. The method further includes adjusting the engine acceleration rate based on the comparison between the actual clearance and the transient target clearance, wherein the transient target clearance is adjusted at least partially based on the adjustment to the engine acceleration rate.

### FIELD

The present subject matter relates generally to gas turbine engines. More particularly, the present subject matter relates to clearance control techniques for gas turbine engines.

### BACKGROUND

Gas turbine engines often include a clearance control system configured to adjust a clearance between rotating turbine blades and a stationary casing to optimize efficiency and prevent contact between the turbine blades and the stationary casing. However, known clearance control systems cannot react fast enough to prevent pinch or rub events in certain rapid acceleration/deceleration scenarios. For example, when the gas turbine engine is required to rapidly accelerate or decelerate, the mechanical expansion rate of the turbine blades exceeds the thermal expansion rate of the casing. In many scenarios, the clearance control system is not quick enough to account for the mechanical expansion of the turbine blades, which may result in the rotor blades rubbing or pinching against the casing of the gas turbine engine. This can potentially cause damage to the gas turbine engine or reduce the engine's efficiency.

Because the turbine blades may grow mechanically faster than the surrounding turbine casing can thermally react (and faster than the clearance control system can react), it is necessary for engine designers to factor in additional clearance to prevent a rub or pinch condition in these situations. However, by increasing the clearance between the end of the rotor blades and the engine casing, more air is able to escape past the rotor blade, instead of traveling through the blades, resulting in decreased gas turbine engine performance and increased fuel burn.

Accordingly, an improved system and method that allows for rapid acceleration and/or deceleration of the gas turbine engine while minimizing the clearance for optimal performance is desired and would be appreciated in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 provides a schematic cross-sectional view of a gas turbine engine according to an example embodiment of the present disclosure;

FIG. 2 provides a schematic cross-sectional view of another gas turbine engine according to an example embodiment of the present disclosure;

FIG. 3 provides a close-up, cross sectional view of the aft end of a combustion section and an HP turbine of the gas turbine engine of FIG. 1;

FIG. 4 is a schematic block diagram of an integrated engine control and flight operation system in accordance with an exemplary embodiment of the present disclosure.

FIG. 5 illustrates a diagram of control logic, which may be implemented by an engine controller for controlling clearances between the turbine blades and a casing by adjusting the acceleration rate of the gas turbine engine, in accordance with embodiments of the present disclosure;

FIG. 6 illustrates another diagram of control logic, which may be implemented by an engine controller for controlling clearances between the turbine blades and a casing by adjusting the deceleration rate of the gas turbine engine, in accordance with embodiments of the present disclosure;

FIG. 7 is a graph of engine speed vs. time in accordance with an exemplary aspect of the present disclosure.

FIG. 8 is a clearance response graph of clearance vs. time, which illustrates how the clearances in the gas turbine engine respond to the adjustments of the acceleration shown in FIG. 7.

FIG. 9 is a graph of engine speed vs. time in accordance with an exemplary aspect of the present disclosure.

FIG. 10 is a clearance response graph of clearance vs. time, which illustrates how the clearances in the gas turbine engine respond to the adjustments of the acceleration rate shown in FIG. 7.

FIG. 11 provides a flow diagram for a method of operating a gas turbine engine in accordance with embodiments of the present disclosure.

FIG. 12 provides a block diagram of an engine controller according to an example embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. “HP” denotes high pressure and “LP” denotes low pressure.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

The present disclosure is generally related to preventing pinch between rotor blades and a casing of a gas turbine engine of an aircraft. In certain operating conditions, such as step-climb conditions or others, the gas turbine engine may be required to rapidly accelerate or decelerate, which causes mechanical and thermal expansion of the rotor blades and thermal expansion of the casing surrounding the rotor blades. In such rapid acceleration/deceleration instances, the mechanical expansion rate of the turbine blades exceed the thermal expansion rate of the casing, which may result in the rotor blades rubbing or pinching against the casing of the gas turbine engine. This can potentially cause damage to the gas turbine engine or reduce the engine's efficiency.

Because the rotor blades may grow mechanically faster than the surrounding turbine casing can thermally react, it is necessary for engine designers to factor in additional clearance to prevent a rub or pinch condition in these situations. However, by increasing the clearance between the end of the rotor blades and the engine casing, more air is able to escape past the rotor blade, instead of traveling through the blades, resulting in decreased gas turbine engine performance and increased fuel burn.

Specifically, as used herein, “acceleration rate” refers to an angular acceleration value at a moment in time (e.g., the time rate of change of an angular velocity of a specified rotating component, such as the LP shaft, the HP shaft, etc. That is, “acceleration rate” does not refer to the rate of change of acceleration (e.g., jerk), but rather to the acceleration value at that moment in time. “Acceleration rate” and “acceleration” may be used interchangeably for the purposes of this disclosure.

The present disclosure is related to a system and method of continuously linking the acceleration rate of the gas turbine engine to a target clearance. For example, when the gas turbine engine is operating in a first flight condition (such as a steady state condition), and a demand is received to operate in a second flight condition (such as a step climb condition), then the gas turbine engine may set a final target clearance to be achieved at the second flight condition and may begin accelerating or decelerating. At one or more points during the acceleration or deceleration to the second flight condition, the system may determine whether the gas turbine engine is on pace to achieve the final target clearance associated with the second flight condition. If not, then the system may adjust the acceleration or deceleration of the gas turbine engine. If so, then the system may continue accelerating or decelerating at the current rate without any adjustments.

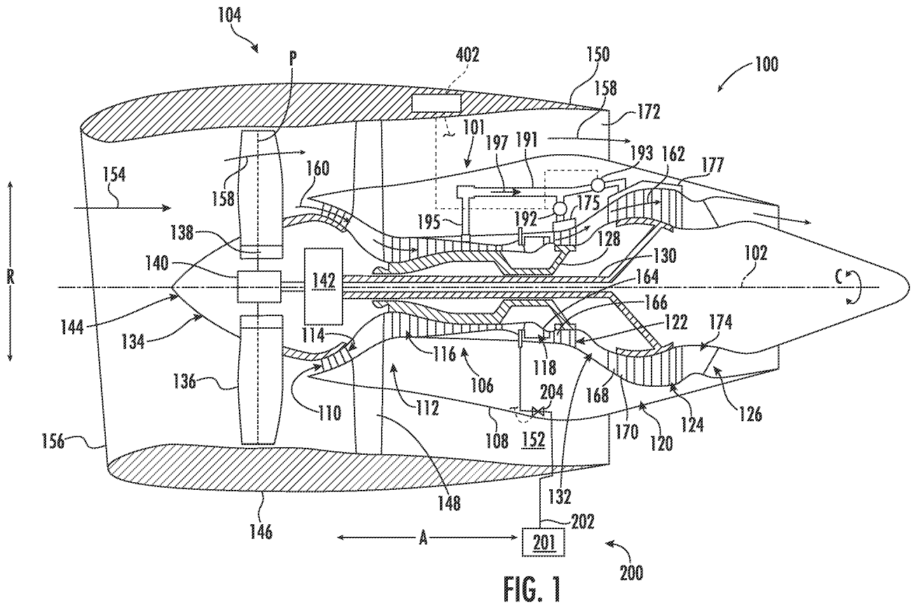

Referring now to the drawings, FIG. 1 provides a schematic cross-sectional view of a gas turbine engine 100 according to an example embodiment of the present disclosure. For the depicted embodiment of FIG. 1, the gas turbine engine 100 is an aeronautical, high-bypass turbofan jet engine configured to be mounted to an aircraft, e.g., in an under-wing configuration. As shown, the gas turbine engine 100 defines an axial direction A, a radial direction R, and a circumferential direction C. The axial direction A extends parallel to or coaxial with a longitudinal centerline 102 defined by the gas turbine engine 100.

The gas turbine engine 100 includes a fan section 104 and a core turbine engine 106 disposed downstream of the fan section 104. The core turbine engine 106 includes an engine cowl 108 that defines an annular inlet 110. The engine cowl 108 encases, in a serial flow relationship, a compressor section 112 including a first, booster or LP compressor 114 and a second, HP compressor 116; a combustion section 118; a turbine section 120 including a first, HP turbine 122 and a second, LP turbine 124; and an exhaust section 126. An HP shaft 128 drivingly connects the HP turbine 122 to the HP compressor 116. An LP shaft 130 drivingly connects the LP turbine 124 to the LP compressor 114. The compressor section 112, combustion section 118, turbine section 120, and exhaust section 126 together define a core air flowpath 132 through the core turbine engine 106.

The fan section 104 includes a fan 134 having a plurality of fan blades 136 coupled to a disk 138 in a circumferentially spaced apart manner. As depicted, the fan blades 136 extend outward from the disk 138 generally along the radial direction R. Each fan blade 136 is rotatable relative to the disk 138 about a pitch axis P by virtue of the fan blades 136 being operatively coupled to a suitable actuation member 140 configured to collectively vary the pitch of the fan blades 136, e.g., in unison. The fan blades 136, disk 138, and actuation member 140 are together rotatable about the longitudinal centerline 102 by the LP shaft 130 across a power gearbox 142. The power gearbox 142 includes a plurality of gears for stepping down the rotational speed of the LP shaft 130 to affect a more efficient rotational fan speed. In other embodiments, the fan blades 136, disk 138, and actuation member 140 can be directly connected to the LP shaft 130, e.g., in a direct-drive configuration. Further, in other embodiments, the fan blades 136 of the fan 134 can be fixed-pitch fan blades.

Referring still to FIG. 1, the disk 138 is covered by a rotatable spinner 144 aerodynamically contoured to promote an airflow through the plurality of fan blades 136. Additionally, the fan section 104 includes an annular fan casing or outer nacelle 146 that circumferentially surrounds the fan 134 and/or at least a portion of the core turbine engine 106. The nacelle 146 is supported relative to the core turbine engine 106 by a plurality of circumferentially-spaced outlet guide vanes 148. A downstream section 150 of the nacelle 146 extends over an outer portion of the core turbine engine 106 so as to define a bypass airflow passage 152 therebetween.

During operation of the gas turbine engine 100, a volume of air 154 enters the gas turbine engine 100 through an associated inlet 156 of the nacelle 146 and/or fan section 104. As the volume of air 154 passes across the fan blades 136, a first portion of the air 154, as indicated by arrows 158, is directed or routed into the bypass airflow passage 152 and a second portion of the air 154, as indicated by arrow 160, is directed or routed into the LP compressor 114. The pressure of the second portion of air 160 is increased as it is routed through the LP compressor 114 and the HP compressor 116. The compressed second portion of air 160 is then discharged into the combustion section 118.

The compressed second portion of air 160 from the compressor section 112 mixes with fuel and is burned within a combustor of the combustion section 118 to provide combustion gases 162. For example, fuel may be supplied from a fuel supply system 200. The fuel supply system 200 may include a fuel storage 201, fuel supply line 202, and a control valve 204 disposed in fluid communication on the fuel supply line 202. The control valve 204 may be operable to adjust an amount of fuel supplied to the combustion section 118. The combustion gases 162 are routed from the combustion section 118 along a hot gas path 174 of the core air flowpath 132 through the HP turbine 122 where a portion of thermal and/or kinetic energy from the combustion gases 162 is extracted via sequential stages of HP turbine stator vanes 164 and HP turbine blades 166. The HP turbine blades 166 are mechanically coupled to the HP shaft 128. Thus, when the HP turbine blades 166 extract energy from the combustion gases 162, the HP shaft 128 rotates, which supports operation of the HP compressor 116. The combustion gases 162 are routed through the LP turbine 124 where a second portion of thermal and kinetic energy is extracted from the combustion gases 162 via sequential stages of LP turbine stator vanes 168 and LP turbine blades 170. The LP turbine blades 170 are coupled to the LP shaft 130. Thus, when the LP turbine blades 170 extract energy from the combustion gases 162, the LP shaft 130 rotates, which supports operation of the LP compressor 114 and the fan 134.

The combustion gases 162 are subsequently routed through the exhaust section 126 of the core turbine engine 106 to provide propulsive thrust. Simultaneously, the pressure of the first portion of air 158 is substantially increased as the first portion of air 158 is routed through the bypass airflow passage 152 before it is exhausted from a fan nozzle exhaust section 172 of the gas turbine engine 100, also providing propulsive thrust. The HP turbine 122, the LP turbine 124, and the exhaust section 126 at least partially define the hot gas path 174 for routing the combustion gases 162 through the core turbine engine 106.

As further shown in FIG. 1, the gas turbine engine 100 includes a clearance adjustment system, which in this embodiment is an active clearance control (ACC) system 101. Generally, the ACC system 101 is configured to dynamically control the blade tip clearances between a rotating component, such as a turbine blade, and a stationary component, such as a shroud. For this embodiment, the ACC system 101 includes one or more compressor supply ducts, such as compressor supply duct 195, that feeds into a supply duct 191. The supply duct 191 provides a conduit for thermal control air 197 to flow from the HP compressor 116 of the compressor section 112 to the HP turbine 122 and/or the LP turbine 124 as shown. Additionally, or alternatively, although not shown in the example embodiment of FIG. 1, the supply duct 191 can be configured to deliver air from the fan section 104 and/or the LP compressor 114 to the HP turbine 122 and/or the LP turbine 124.

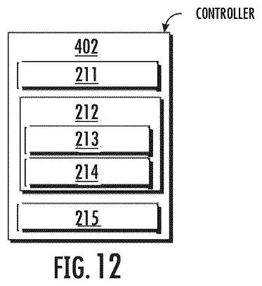

The mass flow and temperature of the thermal control air 197 provided to the HP turbine 122 and/or the LP turbine 124 is controlled by modulating a first control valve 192 and/or a second control valve 193. For this embodiment, the first control valve 192, when modulated, controls the bleed air from the HP compressor 116 to the HP turbine 122. In other embodiments, the source air for the ACC system 101 may come from forward of the compressor section 112, immediately aft of the fan section 104, or other locations. The second control valve 193, when modulated, controls the bleed air from the HP compressor 116 to the LP turbine 124. The first control valve 192 and the second control valve 193, or controllable devices, are controlled by and are communicatively coupled with one or more engine controller(s). In the depicted embodiment of FIG. 1, an engine controller 402 is housed within the nacelle 146. The controller 402 can be, for example, an Electronic Engine Controller (EEC) or an Electronic Control Unit (ECU) of a Full Authority Digital Engine Control (FADEC) system. The engine controller 402 includes various components for performing various operations and functions, such as controlling clearances and/or an acceleration of the gas turbine engine 100. The controller 402 (or computing system) can have one or more processing devices and one or more memory devices. The one or more memory devices, such as one or more non-transitory computer readable medium, can store computer-readable instructions that can be executed by the one or more processing devices to perform operations, such as controlling operations of the gas turbine engine 100. The controller 402 can be configured as shown in FIG. 12.

In many embodiments, the engine controller 402 may be operable to control an acceleration of the gas turbine engine 100 (i.e., a rate of change of the rotational speed of the HP shaft 128 and/or the LP shaft 130). The engine controller may actuate the control valve 204 to adjust an amount of fuel supplied to the combustion section 118 to increase or decrease the acceleration of the gas turbine engine 100. For example, when the control valve 204 is opened, then more fuel is supplied to the combustion section 118, which increases the acceleration of the HP shaft 128 and/or the LP shaft 130 and the entire gas turbine engine 100.

When the control valves 192, 193 are open, the relatively cool or hot thermal control air 197 flows from the HP compressor 116 to the HP turbine 122 and the LP turbine 124. When the thermal control air 197 reaches the HP turbine 122, a distribution manifold 175 associated with the HP turbine 122 distributes the thermal control air 197 about the HP turbine 122 such that the blade tip clearances can be controlled. When the thermal control air 197 reaches the LP turbine 124, a distribution manifold 177 associated with the LP turbine 124 distributes the thermal control air 197 about the LP turbine 124 such that the blade tip clearances can be controlled. When the control valves 192, 193 are closed, thermal control air 197 is restricted from flowing to the HP turbine 122 and LP turbine 124, which results in minimal control air being supplied to the casing. When one of the control valves 192, 193 is opened and one is closed, thermal control air 197 is allowed to flow to the turbine associated with the open control valve while the thermal control air 197 is restricted from flowing to the turbine associated with the closed control valve.

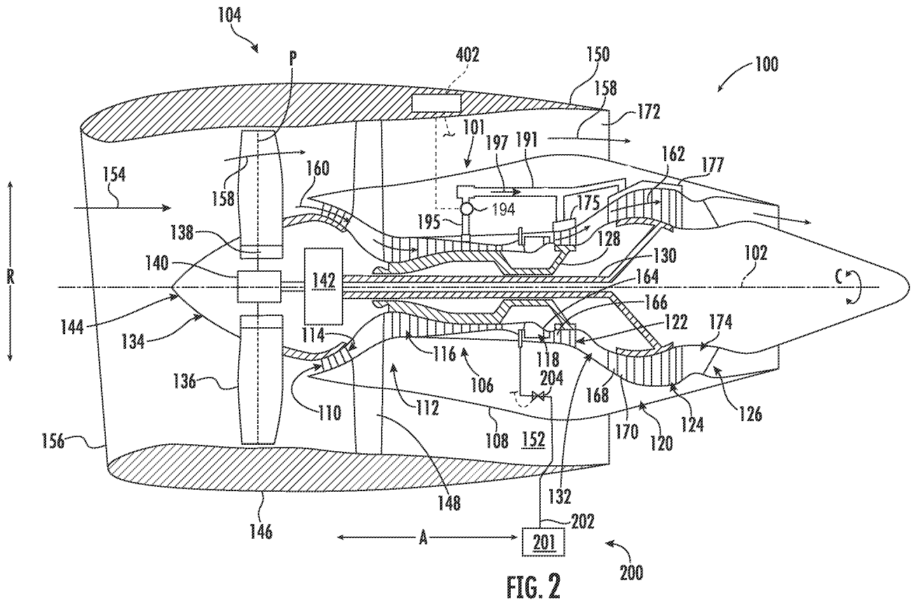

Although the embodiment of FIG. 1 is shown having two control valves 192, 193, it will be appreciated that any suitable number of control valves can be included. In some alternative embodiments, such as depicted in FIG. 2, the ACC system 101 can include a single control valve 194 that selectively allows thermal control air 197 to flow to the HP turbine 122 and the LP turbine 124. In such embodiments, as shown, the control valve 194 may be disposed on (and in fluid communication with) the compressor supply duct 195 (e.g., upstream of supply duct 191). In other embodiments, one or more control valves can be positioned along a supply duct configured to deliver air from the fan section 104 to the HP turbine 122 and/or the LP turbine 124. Other configurations are possible.

In addition, it will be appreciated that the ACC system 101 depicted in FIG. 1 is one example clearance adjustment system. In other example embodiments, the clearance adjustment system can have other suitable configurations. For instance, in one some embodiments, the clearance adjustment system can include one or more electrical heating elements with no or fixed cooling air to modulate clearances. Other clearance adjustment systems are contemplated.

Further, it will be appreciated that the gas turbine engine 100 depicted in FIG. 1 is provided by way of example only, and that in other example embodiments, the gas turbine engine 100 may have any other suitable configuration. Additionally, or alternatively, aspects of the present disclosure may be utilized with any other suitable aeronautical gas turbine engine, such as a turboshaft engine, turboprop engine, turbojet engine, etc. Further, aspects of the present disclosure may further be utilized with any other land-based gas turbine engine, such as a power generation gas turbine engine, or any aeroderivative gas turbine engine, such as a nautical gas turbine engine.

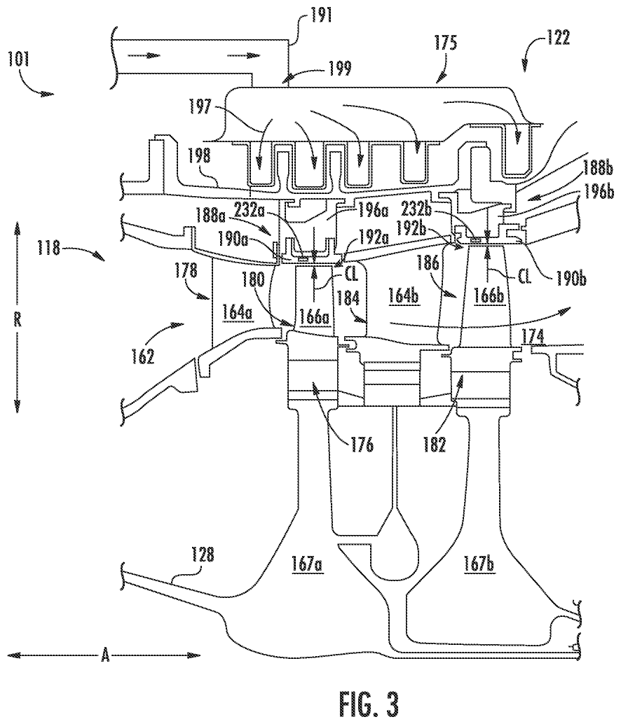

FIG. 3 provides a close-up cross sectional view of the aft end of the combustion section 118 and the HP turbine 122 of the gas turbine engine 100 of FIG. 1. As shown in the example embodiment of FIG. 3, the HP turbine 122 includes, in serial flow relationship, a first stage 176 that includes an annular array 178 of stator vanes 164a (only one shown) axially spaced from an annular array 180 of turbine blades 166a (only one shown). The HP turbine 122 further includes a second stage 182 that includes an annular array 184 of stator vanes 164b (only one shown) axially spaced from an annular array 186 of turbine blades 166b (only one shown). The turbine blades 166a, 166b extend radially from and are coupled to the HP shaft 128 by rotor disks 167a. 167b. The stator vanes 164a, 164b and the turbine blades 166a, 166b rout combustion gases 162 from the combustion section 118 through the HP turbine 122 along the hot gas path 174.

As further depicted in FIG. 3, the HP turbine 122 includes shroud assemblies 188a, 188b each forming an annular ring about an annular array of blades. Particularly, the shroud assembly 188a forms an annular ring around the annular array 180 of blades 166a of the first stage 176, and the shroud assembly 188b forms an annular ring around the annular array 186 of turbine blades 166b of the second stage 182. For this embodiment, the shroud assemblies 188a, 188b include shrouds 190a, 190b that are coupled with respective hangers 196a. 196b, which are in turn coupled with a turbine casing 198.

The shrouds 190a, 190b of the shroud assemblies 188a, 188b are radially spaced from blade tips 192a, 192b of turbine blades 166a, 166b. A blade tip clearance CL is defined between the blade tips 192a, 192b and the shrouds 190a, 190b. It should be noted that the blade tip clearances CL may similarly exist in the LP compressor 114, HP compressor 116, and/or LP turbine 124. Accordingly, the present subject matter disclosed herein is not limited to adjusting blade tip clearances and/or clearance closures in HP turbines; rather, the teachings of the present disclosure may be utilized to adjust blade tip clearances in any suitable section of the gas turbine engine 100.

As noted previously, the ACC system 101 modulates a flow of relatively cool or hot thermal control air 197 from the fan section 104 and/or compressor section 112 and disperses the air on the HP and/or LP turbine casing (e.g., the turbine casing 198 of the HP turbine 122) to shrink or expand the turbine casings relative to the HP/LP turbine blade tips depending on the operational and flight conditions of the aircraft and engine, among other factors. As shown in FIG. 3, the thermal control air 197 is routed to the HP turbine 122 via the supply duct 191. In some implementations, thermal control air 197 can be routed through a heat exchanger (not shown) for further cooling or warming of the air. The thermal control air 197 enters the distribution manifold 175 through an inlet 199 defined by the distribution manifold 175. The thermal control air 197 is distributed via the distribution manifold 175 over the turbine casing 198. In this way, the blade tip clearances CL can be controlled. The amount of thermal control air 197 provided to the HP turbine 122 (and/or LP turbine 124) can be controlled by modulating the control valves 192, 193 (FIG. 1) as explained above.

It will be appreciated that engine performance is dependent at least in part on the blade tip clearances CL between the turbine blade tips and shrouds. Generally, the tighter the clearance between the blade tips and shrouds (i.e., the more closed the clearances), the more efficient the gas turbine engine can be operated. Thus, minimizing or otherwise reducing the blade tip clearances CL facilitates optimal and/or otherwise improved engine performance and efficiency. A challenge in minimizing the blade tip clearances CL, however, is that the turbine blades expand and contract at different rates than the shrouds and casings circumferentially surrounding them.

More particularly, the blade tip clearances CL between turbine blade tips and the surrounding shrouds and turbine casings may be impacted by two main types of loads: power-induced engine loads and flight loads. Power-induced engine loads generally include centrifugal, thermal, internal pressure, and thrust loads. Flight loads generally include inertial, aerodynamic, and gyroscopic loads. Centrifugal and thermal engine loads are responsible for the largest radial variation in blade tip clearances CL. With regard to centrifugal loads, the blades of turbine engines may mechanically expand or contract depending on their rotational speed. Generally, the faster the rotational speed of the rotor, the greater the mechanical expansion of the turbine blades and thus the further radially outward the blades extend. Conversely, the slower the rotational speed of the rotor, the less mechanical expansion the rotor experiences and the further radially inward the blades extend from the centerline longitudinal axis of the engine. With regard to thermal loads, as the engine heats up or cools down due at least in part to power level changes (i.e., changes in engine speed), the rotor and casings thermally expand and/or contract at differing rates. That is, the rotor is relatively large and heavy, and thus the thermal mass of the rotor heats up and cools down at a much slower rate than does the relatively thin and light turbine casings. Thus, the thermal mass of the casings heats up and cools off much faster than the rotor.

Accordingly, as an aircraft maneuvers and its engines perform various power level changes, the rotor and casings contract and expand at different rates. As such, the rotor and casings are sometimes not thermally matched. This mismatch leads to changes in the blade tip clearances CL, and, in some cases, the turbomachinery components may come into contact with or rub one another, causing a rub event. For example, a rub event may occur where a blade tip 192a, 192b comes into contact with or touches a corresponding shroud 190a, 190b. Rub events may cause poor engine performance and efficiency, may reduce the effective service lives of the turbine blades 166a, 166b and/or the shrouds 190a, 190b, and may deteriorate the exhaust gas temperature margin of the engine. Thus, ideally, the blade tip clearances CL are set so as to minimize the clearance between the blade tips and the shrouds without the turbomachinery components experiencing rub events. Taking these aspects into consideration, control techniques for setting clearances are provided herein.

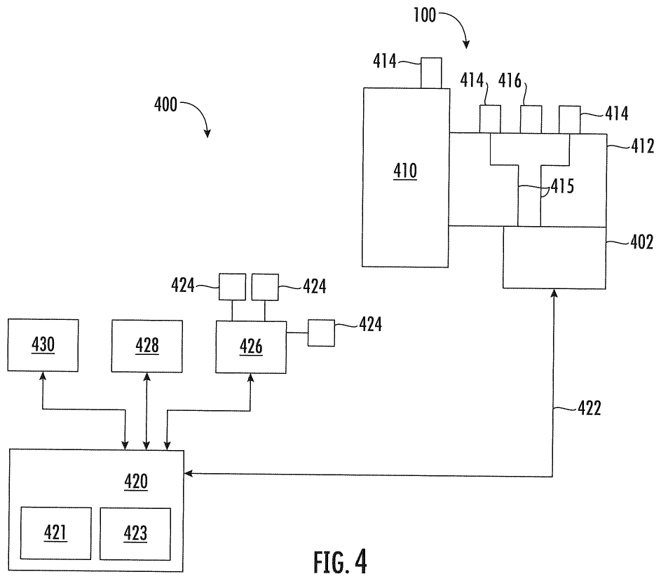

FIG. 4 is a schematic block diagram of an integrated engine control and flight operation system 400 in accordance with an exemplary embodiment of the present disclosure. In the exemplary embodiment, integrated system 400 includes an engine controller 402 such as, but not limited to, a FADEC, mounted proximate to an associated aircraft engine or gas turbine engine 100. Gas turbine engine 100 includes a fan 410 and a core engine 412 in serial flow communication. In some embodiments, substantially all air flow through fan 410 goes through core engine 412. In various embodiments, the gas turbine engine 100 is a high bypass type engine and only a portion of the airflow entering fan 410 passes through core engine 412. Although described as a FADEC, in various embodiments, engine controller 402 may include other forms of engine controller capable of operating as described herein.

A plurality of process sensors 414 are positioned about the gas turbine engine 100 to sense process parameters associated with the gas turbine engine 100. Such process parameters include for example, engine speed, fuel flow, damper and guide vane positions, stator vane clearance, as well as various temperatures of components in the gas turbine engine 100. Sensors 414 are communicatively coupled to engine controller 402. For example, the captured values, or sensor data 415, can be routed to the engine controller 402. The one or more sensors 414 can continuously capture operating parameter values, may do so at predetermined intervals, and/or upon a condition being satisfied.

In some embodiments, the one or more sensors 414 can include at least one sensor operable to directly measure the clearance between a rotating component and a stationary component of the gas turbine engine 100. For instance, the one or more sensors 414 can include a sensor 232a (FIG. 3) operable to measure the clearance between the turbine blade 166a and the shroud 190a. The one or more sensors 414 can also include a sensor 232b (FIG. 3) operable to measure the clearance between the turbine blade 166b and the shroud 190b. The sensors 232a, 232b can be optical probes, inductive proximity sensors, a combination thereof, or any suitable type of sensors operable to directly measure the clearance between their respective rotating and stationary components. The sensors 232a, 232b can each capture an instantaneous clearance between their respective turbine blades 166a, 166b and shrouds 190a, 190b and may provide the instantaneous clearances, or measured clearances, to the engine controller 402 as part of the sensor data 415.

The one or more sensors 414 can also include at least one sensor operable to directly measure the clearance between a rotating component and a stationary component of the LP turbine 124. The sensor positioned in the LP turbine 124 can capture an instantaneous clearance between an LP turbine blade 170 (or an array of LP turbine blades) and its associated shroud and may provide the instantaneous clearance, or measured clearance, to the engine controller 402 as part of the sensor data 415.

The one or more sensors 414 can also include other sensor(s). The one or more sensors 414 can include sensor(s) operable to capture or measure operating parameter values for various operating parameters, such as various speeds, pressures, temperatures, etc., that indicate the operating conditions or operating point of the gas turbine engine 100. Example operating parameters include, without limitation, a shaft speed of the LP shaft 130, a shaft speed of the HP shaft 128, a compressor discharge pressure, an ambient temperature, an ambient pressure, a temperature along the hot gas path 174 between the HP turbine 122 and the LP turbine 124, an altitude at which the gas turbine engine 100 is operating, etc. Such sensors can measure or capture the operating parameter values for their respective operating parameters and such operating parameter values can be routed to the engine controller 402 as part of the sensor data 415. The sensor data 415 can also include data indicating a power level of the gas turbine engine 100, e.g., based on a position of a throttle of the gas turbine engine 100.

In many embodiments, the sensors 414 may be operable to capture or measure an acceleration of the gas turbine engine 100. That is, the rate of change of the speed at which the LP shaft 130 and/or the HP shaft 128 is rotating. In other embodiments, the one or more sensors 414 may be operable to capture or measure the speed of the LP shaft 130 and/or the shaft speed of the HP shaft 128, and using the measured speeds, the engine controller 402 can determine the engine acceleration. In exemplary implementations, the engine controller 402 may be operable to adjust the engine acceleration, such as by adjusting (i.e., increasing or decreasing) the amount of fuel supplied to the combustion section 118.

In addition, one or more actuators 416 are positioned about gas turbine engine 100 and are operably coupled to components of gas turbine engine 100 to effect the operation of those components. Actuators 416 are also communicatively coupled to engine controller 402. In one embodiment, actuators 416 are in communication with the control valves 192, 193, 194, 204. Actuators 416 may receive commands to open or close one or more control valves 192, 193, 194 to control the heating/cooling flow delivered of the engine response schedules, described further herein. Additionally, actuators 416 may receive commands to adjust the amount of fuel supplied to the combustion section 118 by actuating the control valve 204, which adjusts an acceleration of the gas turbine engine. Sensors 414 and actuators 416 are used by engine controller 402 to determine operating conditions of gas turbine engine 100, including but not limited to, a performance of gas turbine engine 100 relative to a baseline or new operating condition. Engine controller 402 may then operate actuators 416 to account for deterioration and/or damage to gas turbine engine 100 between overhauls. Engine controller 402 may also use sensors 414 and actuators 416 to store the determined engine condition for future reference, further processing, and/or reporting.

System 400 also includes a flight control system 420 (e.g., flight management system or FMS) communicatively coupled to engine controller 402 through a communications channel 422. Flight control system 420 includes a processor 421 and a memory 423 communicatively coupled to processor 421. In the exemplary embodiment of FIG. 4, communications channel 422 is a wired connection between engine controller 402 and flight control system 420. In various other embodiments, communications channel 422 may be a wireless communication medium. In the exemplary embodiment, flight control system 420 is located proximate a cockpit (not shown) of the aircraft, and engine controller 402 is located proximate the engine to which it is associated. Flight control system 420 may be embodied in a single processor-based component, or the functions of flight control system 420 may be carried out by a plurality of components configured to perform the functions described herein. Some of the components performing the functions of flight control system 420 may be located proximate the cockpit and others may be distributed inside the aircraft for convenience, safety, and/or optimal operational considerations. Although the flight control system is described herein as a flight management system (FMS), it is to be understood that the systems and methods described herein include communication between an engine controller and any aircraft-mounted avionics function.

Flight control system 420 is configured to interface with various other systems both onboard the aircraft and offboard the aircraft. For example, flight control system 420 may receive current aircraft status from a plurality of aircraft sensors 424 through a sensing system 426. Such sensors may include pitot tubes for determining airspeed, gyros, compasses, accelerometers, position sensors, altimeters, and various other sensors that may be able to detect a condition, status, or position of the aircraft (such as aircraft orientation, time to target, or other conditions). Flight control system 420 may also receive information from one or more onboard processing systems 428, which may be standalone systems or systems having functions distributed across several computer systems. Flight control system 420 and onboard processing systems 428 may communicate using a wired communications channel and/or network connection (e.g., Ethernet or an optical fiber), a wireless communication means, such as radio frequency (RF), e.g., FM radio and/or digital audio broadcasting, an Institute of Electrical and Electronics Engineers (IEEE®) 802.11 standard (e.g., 802.11 (g) or 802.11 (n)), the Worldwide Interoperability for Microwave Access (WIMAX®) standard, cellular phone technology (e.g., the Global Standard for Mobile communication (GSM)), a satellite communication link, and/or any other suitable communication means. As used herein, a wired communications channel includes channels that use fiber and other optical means for communications. Flight control system 420 may also receive information from one or more offboard processing systems 430, which may be standalone systems or systems having functions distributed across several computer systems and/or several sites. Offboard processing systems 430 and flight control system 420 are communicatively coupled using one or more wireless communications media including, but not limited to, radio frequency (RF), e.g., FM radio and/or digital audio broadcasting, an Institute of Electrical and Electronics Engineers (IEEE®) 802.11 standard (e.g., 802.11 (g) or 802.11 (n)), the Worldwide Interoperability for Microwave Access (WIMAX®) standard, cellular phone technology (e.g., the Global Standard for Mobile communication (GSM)), a satellite communication link, and/or any other suitable communication means.

As in at least some aircraft operating procedures, a step climb condition occurs when the pilot of an aircraft elects to increase the altitude at which the aircraft is traveling. Altitude steps generally occur in 2,000 feet increments, as dictated by current FAA regulations. This means, for example, that the pilot of an aircraft flying at 33,000 feet may elect to undertake a step climb maneuver to cause the aircraft to climb 2,000 feet to an altitude of 35,000 feet. In order to effectuate the step climb, the pilot modifies the controls of an auto-pilot/auto-throttle system of the flight control system 420 to request that the aircraft ascend to the desired cruising altitude. The flight control system 420 then uses predetermined algorithms to increase engine power in order to cause the aircraft to climb. Because a request for increased engine power conventionally necessitates that the gas turbine engine 100 accelerate, which increases engine thrust, turbine blades 166 (e.g., rotor blades) grow due to mechanical forces and associated thermal changes. This turbine blade growth causes clearances to be reduced. If the growth exceeds design tolerances, the turbine blades may rub or pinch against the casing of the gas turbine engine 100, potentially causing damage or reducing the engine's efficiency.

With the ACC system 101, thermal growth of the gas turbine engine 100 casing can be matched to the thermal and mechanical growth of the turbine blades 166 if adequate time is given for the clearance control system to operate. For example, a step climb from approximately 33,000 to 35,000 feet may take the aircraft more than two minutes to accomplish. Known flight control system step climb algorithms, however, command gas turbine engine 100 response to a request for increased thrust within, for example, 5 seconds, causing the rate of growth of turbine blades 166 to exceed the rate of growth of the turbine casing 198. Because the turbine blades 166 grow mechanically faster than the surrounding turbine casing 198 can thermally react, it is necessary for engine 100 designers to factor in additional clearance to prevent a rub or pinch condition in these situations (e.g., in an acceleration or deceleration situation in which the turbine blades 166 grow mechanically faster than the casing 198). In the above example, the additional clearance is referred to herein as step-climb headroom. However, by increasing the clearance between the end of the turbine blades 166 and the engine casing 198, more air is able to escape past the turbine blade, instead of traveling through the blades, resulting in decreased gas turbine engine 100 performance and increased fuel burn.

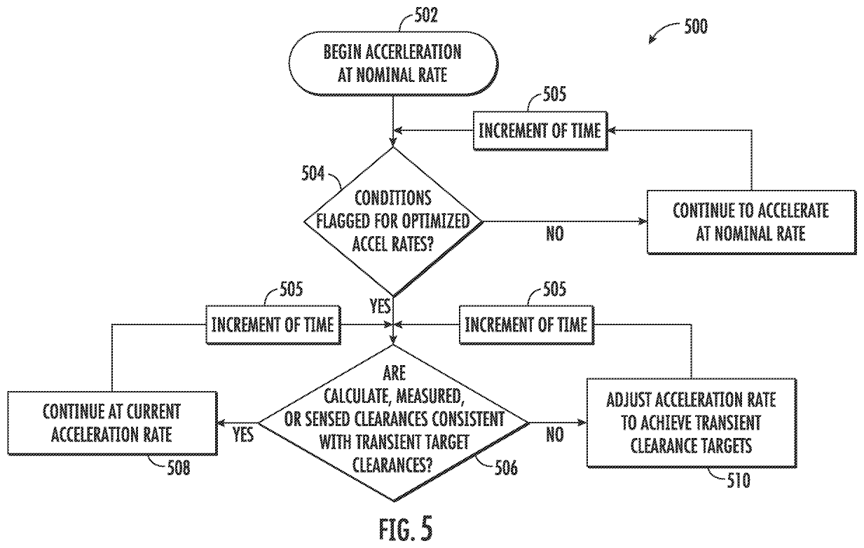

FIGS. 5 and 6 each illustrate a diagram of control logic 500 and 600, which may be implemented by the engine controller 402, for controlling clearances (such as the blade tip clearance CL) between the blade tips 192a, 192b and the shrouds 190a, 190b (FIG. 3) by adjusting the acceleration rate of the gas turbine engine 100. The engine controller 402 may implement the control logic 500 and/or 600 in response to a demand for a new flight condition. For example, when the gas turbine engine 100 is operating in a first flight condition (such as a steady state condition) and a demand is received by the engine controller 402 for a second flight condition (such as a step climb condition, acceleration condition, or deceleration condition), then the engine controller 402 may implement the control logic 500 or 600.

Referring specifically to FIG. 5, in response to receiving a demand for a new flight condition, the control logic may include at (502) an initial step of beginning an acceleration of the gas turbine engine at a nominal acceleration rate. The nominal acceleration rate may be a predetermined acceleration rate that the engine controller 402 may implement by default, until conditions are flagged for an optimized acceleration rate based on transient target clearances. The nominal acceleration rate may include an HP nominal acceleration rate for the HP shaft 128 and an LP nominal acceleration rate for the LP shaft 130. The HP nominal acceleration rate may be the same or different than the LP nominal acceleration rate.

In many embodiments, the control logic may include at (504) determining whether or not the gas turbine engine 100 operational conditions are flagged for an optimized acceleration rate (e.g., a deviation or modification from the nominal acceleration rate). Many operational conditions of the gas turbine engine 100 may be flagged for the optimized acceleration rate, such as a most acceleration conditions (when the gas turbine engine is accelerating from a first speed to a second speed), step climb conditions, or others. However, some operational conditions, proceeding at the nominal acceleration rate may be optimal. For example, if the aircraft is in close proximity to the runway (such as takeoff or landing conditions). The engine controller 402 may identify when operational conditions of the gas turbine engine 100 are optimal for application of the optimized acceleration rate to ensure the optimized acceleration rates are not applied at inappropriate times.

When the engine controller 402 determines that operational conditions of the gas turbine engine 100 are such that an optimized acceleration rate may be implemented, the control logic diagram 500 may include at (506) determining, with the engine controller 402, whether the calculated, measured, and/or sensed clearances are consistent with the transient target clearances. That is, the engine controller 402 may compare the calculated, measured, and/or sensed clearances between the blade tips 192a, 192b and the shrouds 190a, 190b (FIG. 3) to the target clearances at the particular instance in time.

When the calculated, measured, and/or sensed clearances between the blade tips 192a, 192b and the shrouds 190a, 190b (FIG. 3) are inside of a predetermined margin of the target clearance for that particular instance in time (e.g., inside of a ±15% margin, or such as inside of a ±10% margin, or such as inside of a ±5% margin, or such as inside of a ±1% margin), then the control logic may include at (508) continuing at the current acceleration rate (i.e., not modifying or adjusting the acceleration of the gas turbine engine 100).

However, when the calculated, measured, and/or sensed clearances between the blade tips 192a, 192b and the shrouds 190a, 190b (FIG. 3) are outside of the predetermined margin of the target clearance for that particular instance in time (e.g., outside of a ±15% margin, or such as outside of a ±10% margin, or such as outside of a ±5% margin, or such as outside of a ±1% margin), then the control logic may include at (510) adjusting the acceleration rate to achieve the transient target clearance. For example, when the calculated, measured, and/or sensed clearances between the blade tips 192a, 192b and the shrouds 190a, 190b (FIG. 3) are outside of the predetermined margin of the target clearance for that particular instance in time, the acceleration rate may be either increased or decreased to achieve the transient target clearance. In one example, when it is determined that the actual clearance exceeds a predetermined margin of the transient target clearance (e.g., is greater than an upper threshold of the predetermined margin, i.e., the clearance is big and may cause inefficiencies), then the engine acceleration rate may be increased until the actual clearance is within the predetermined margin of the transient clearance. In another example, when it is determined that the actual clearance is less than a predetermined margin of the transient target clearance (e.g., is than a lower threshold of the predetermined margin, i.e., the clearance is too small and may result in a pinch/rub), then the engine acceleration rate may be decreased until the actual clearance is within the predetermined margin of the transient clearance. In other words, when the gas turbine engine is in a transient state (i.e., while the gas turbine engine 100 transitioning from a first operating condition to second operating condition by accelerating/decelerating), the engine controller 402 may periodically (or continuously in some embodiments) determine whether the measured, sensed, and/or calculated clearance between the blade tips 192a. 192b and the shrouds 190a, 190b (FIG. 3) is within a predetermined margin of the target clearance (such as within ±5%, or within ±10%, or within ±20%) at that particular moment in time (if not, the engine controller may adjust the acceleration rate).

In various instances, as shown in FIG. 5, the engine controller 402 may wait an increment of time at (505) before repeating the decision steps (504) and/or (506). The increment of time may be a standard increment, such as a between about 60 seconds and about 0.1 seconds, or such as between about 30 seconds and about 0.1 seconds, or such as between about 10 seconds and about 0.1 seconds, or such as between about 1 seconds and about 0.1 seconds. In some embodiments, the increment of time may be zero such that the logic continually loops until the target clearance is achieved. In some embodiments, the increment of time may be the rate of recalculation of the engine controller, which may be between about 0.05 seconds and about 0.4 seconds. In many implementations, the control logic may iterate steps (506), (508) or (510), and (505) until the gas turbine engine 100 is operating in the second flight condition and/or the gas turbine engine has achieved the final target clearance. Additionally, the engine controller may iterate steps (502), (504), and (505) until the gas turbine engine 100 is operating in the second flight condition and/or the gas turbine engine 100 has achieved the final target clearance. In some embodiments, the iteration may be at a set pace, which may be equal to the increment of time. In other embodiments, the iteration may be continuous.

Referring specifically to FIG. 6, in response to receiving a demand for a new flight condition, the control logic may include at (602) an initial step of beginning deceleration of the gas turbine engine at a nominal deceleration rate. The nominal deceleration rate may be a predetermined deceleration rate that the engine controller 402 may implement by default, until conditions are flagged for an optimized deceleration rate. The nominal deceleration rate may include an HP nominal deceleration rate for the HP shaft 128 and an LP nominal deceleration rate for the LP shaft 130. The HP nominal deceleration rate may be the same or different than the LP nominal deceleration rate.

In many embodiments, the control logic may include at (604) determining whether or not the gas turbine engine 100 operational conditions are flagged for an optimized deceleration rate (e.g., a deviation or modification from the nominal deceleration rate) in order to maintain proper clearances. Many operational conditions of the gas turbine engine 100 may be flagged for the optimized deceleration rate, such as a most deceleration conditions (when the gas turbine engine is decelerating from a first speed to a second speed). Additionally, the engine controller 402 may flag the operational conditions for optimized deceleration rates when a hot rotor and re-acceleration is required, in order to lessen the likely hood of a pinch or rub event during the re-acceleration of the gas turbine engine 100. For example, as discussed above, the rotor and casings thermally expand and/or contract at differing rates. That is, the rotor is relatively large and heavy, and, thus, the thermal mass of the rotor heats up and cools down at a much slower rate than does the relatively thin and light turbine casings. Thus, the thermal mass of the casings heats up and cools off much faster than the rotor. A hot rotor re-acceleration scenario may occur after deceleration of the gas turbine engine. For example, during deceleration the casing cools and thermally retracts while the rotor stays hot and thermally expanded, such that when the gas turbine engine re-accelerates, the turbine blades have less room for mechanical expansion, which can result in a pinch or rub event. The engine controller 402 may flag conditions at (604) for optimized deceleration when a hot rotor re-acceleration scenario is anticipated (i.e., the engine controller 402 determines that the gas turbine engine 100 will re-accelerate within some predetermined time period after the gas turbine engine 100 decelerates).

However, in some operational conditions, proceeding at the nominal deceleration rate may be optimal. For example, if the aircraft is in close proximity to the runway (such as takeoff or landing conditions). The engine controller 402 may identify when operational conditions of the gas turbine engine 100 are optimal for application of the optimized deceleration rate to ensure the optimized deceleration rates are not applied at inappropriate times.

When the engine controller 402 determines that operational conditions of the gas turbine engine 100 are such that an optimized deceleration rate may be implemented, the control logic 600 may include at (606) determining, with the engine controller 402, whether the calculated, measured, and/or sensed clearances are consistent with the transient target clearances. That is, the engine controller 402 may compare the calculated, measured, and/or sensed clearances between the blade tips 192a, 192b and the shrouds 190a, 190b (FIG. 3) to the target clearances at the particular instance in time.

When the calculated, measured, and/or sensed clearances between the blade tips 192a, 192b and the shrouds 190a, 190b (FIG. 3) are inside of a predetermined margin of the target clearance for that particular instance in time (e.g., inside of a ±15% margin, or such as inside of a ±10% margin, or such as inside of a ±5% margin, or such as inside of a ±1% margin), then the control logic may include at (608) continuing at the current deceleration rate (i.e., not modifying or adjusting the deceleration of the gas turbine engine 100).

However, when the calculated, measured, and/or sensed clearances between the blade tips 192a, 192b and the shrouds 190a, 190b (FIG. 3) are outside of the predetermined margin of the target clearance for that particular instance in time (e.g., outside of a ±15% margin, or such as outside of a ±10% margin, or such as outside of a ±5% margin, or such as outside of a ±1% margin), then the control logic may include at (610) adjusting the deceleration rate to achieve the transient target clearance. Particularly, in one non-limiting example, when the calculated, measured, and/or sensed clearances between the blade tips 192a, 192b and the shrouds 190a, 190b (FIG. 3) are greater than the predetermined margin of the target clearance at an instance in time, then the deceleration rate may be increased.

In other words, while the gas turbine engine is in a transient state (i.e., while the gas turbine engine 100 transitioning from a first operating condition to second operating condition by accelerating/decelerating), the engine controller 402 may periodically (or continuously in some embodiments) determine whether the measured, sensed, and/or calculated clearance between the blade tips 192a, 192b and the shrouds 190a, 190b (FIG. 3) is within a predetermined margin of the target clearance at that particular moment in time (if not, the engine controller may adjust the deceleration rate).

In various instances, as shown in FIG. 6, the engine controller 402 may wait an increment of time at (605) before performing the decision steps (604) and/or (606). The increment of time may be a standard increment, such as a between about 60 seconds and about 0.1 seconds, or such as between about 30 seconds and about 0.1 seconds, or such as between about 15 seconds and about 0.1 seconds. In some embodiments, the increment of time may be equal to a rate of recalculation of the engine controller, which may be between about 0.05 seconds and about 0.4 seconds, or such as between about 0.1 seconds and about 0.3 seconds. In many implementations, the control logic may iterate steps (606), (608) or (610), and (605) until the gas turbine engine 100 is operating in the second flight condition and/or the gas turbine engine has achieved the final target clearance. Additionally, the engine controller may iterate steps (602), (604), and (605) until the gas turbine engine 100 is operating in the second flight condition and/or the gas turbine engine 100 has achieved the final target clearance. In some embodiments, the iteration may be at a set pace, which may be equal to the increment of time. In other embodiments, the iteration may be continuous.

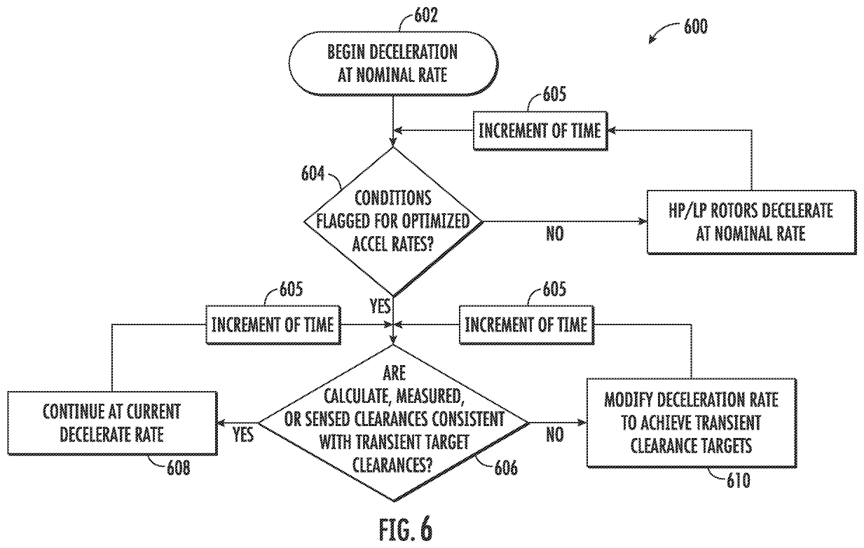

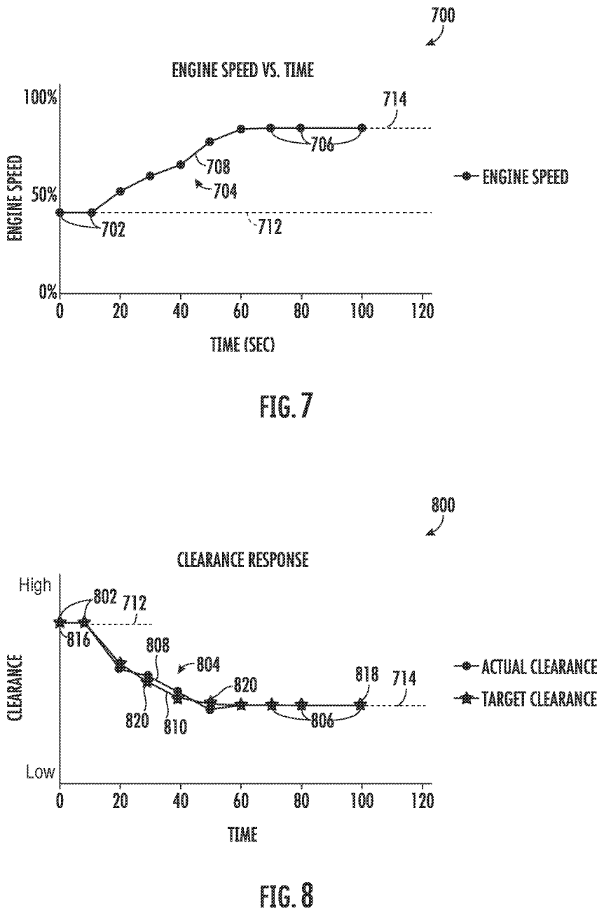

FIGS. 7 and 8 graphically depict the advantages and benefits of the control logic 500 described above with reference to FIG. 5. For example, FIG. 7 is a graph 700 of engine speed vs. time, in which time is plotted on the X-axis and engine speed is plotted on the Y-axis. The engine speed may be between 0% speed and 100% speed. The engine speed may be a rotational speed of the HP shaft 128 and/or the LP shaft 130. FIG. 8 is a clearance response graph 800 of clearance vs. time, in which time is plotted on the X-axis and the clearance (e.g., between the blade tips 192a, 192b and the shrouds 190a, 190b shown in FIG. 3) is plotted on the Y-axis. The clearance may be between a low or small clearance value (e.g., the tips of the rotor blades are close or contacting the casing) and a high or large clearance value (such that the tips of the rotor blades are far from the casing).

The graph 700 may include an engine speed line 708, which is representative of the rotational speed of the HP shaft 128 and/or the LP shaft 130 at the particular instances in time shown. By contrast, the clearance response graph 800 may include an actual clearance line 808 representative of the actual clearance (e.g., the measured, sensed, and/or calculated clearance between the blade tips 192a, 192b and the shrouds 190a, 190b at the particular instance in time) and a target clearance line 810 representative of the target clearance (e.g., clearances generated by the engine controller 402 for optimal performance of the gas turbine engine 100). As shown in FIG. 8, the points of the actual clearance line 808 are plotted with circles, and the points of the target clearance line 810 are plotted with stars.

FIGS. 7 and 8 should be viewed collectively to appreciate the clearance response of the gas turbine engine 100 as a result of adjustments to the acceleration rate. For example, each of the graphs 700, 800 share a common time X-axis and a common number of data points plotted in 10 second increments. As shown in FIGS. 7 and 8, the lines 708, 808 may include initial points 702, 802, which are associated with the first flight condition 712 (such as a steady state condition) of the gas turbine engine 100. For example, the initial points 702 may be the engine speed (e.g., the rotational speed of the HP shaft 128 and/or the LP shaft 130) in the first flight condition 712. Similarly, the initial points 802 may be the actual clearance between the turbine blades and the turbine casing in the first flight condition 712. Additionally, as shown in FIGS. 7 and 8, the lines 708, 808 may include final points 706, 806, which are associated with a final flight condition 714 (such as a step-climb condition) that is different than the first flight condition 712. For example, the final points 706 may be the engine speed (e.g., the rotational speed of the HP shaft 128 and/or the LP shaft 130) in the final flight condition 714. Similarly, the final points 806 may be the clearance in the final flight condition 714. Additionally, each of the lines 708, 808 may include a plurality of transient points 704, 804 between the initial points 702, 802 and the final points 706, 806 as the gas turbine engine 100 transitions between the first flight condition 712 and the final flight condition 714.

The engine controller 402 may determine a plurality of transient target clearances 820 between the initial clearance 816 (e.g., when the gas turbine is operating in the first flight condition 712) and the final target clearance 818 (e.g., when the gas turbine engine is operating in the final flight condition 714). For example, when the gas turbine engine 100 is operating in a first flight condition 712 (such as a steady state condition) and a demand is received by the engine controller 402 for a final flight condition 714 different than the first flight condition 712 (such that an acceleration/deceleration is required), the engine controller 402 may generate, determine, or set a final target clearance 818 associated with the final flight condition 714 and a plurality of transient target clearances 820 between the initial clearance 816 and the final target clearance 818. The plurality of transient target clearances 816 may be predetermined or may be determined based on the current operating conditions of the gas turbine engine 100. For example, in some embodiments, each of the intermediate target clearance may be determined based on the current acceleration rate of the gas turbine engine 100 and/or based on other parameters associated with the gas turbine engine 100. For example, each of the transient target clearances may be determined based on various speeds, accelerations, pressures, and/or temperatures, etc. associated with the gas turbine engine 100.

As the gas turbine engine 100 is transitioning between the first flight condition 712 and the final flight condition 714, the engine controller 402 may periodically (e.g., every 10 seconds as shown in FIGS. 7 and 8) compare the actual clearance line 808 to the target clearance line 810. If the actual clearance value is outside of a predetermined margin of the target clearance value at the particular point in time of the comparison, then the engine controller 402 may adjust the acceleration rate of the gas turbine engine 100. For example, as shown in FIGS. 7 and 8 collectively, during the transitory state between the first flight condition 712 and the final flight condition 714, the engine controller 402 may adjust the acceleration rate (e.g., as shown by the changing slope of the engine speed line 708 in FIG. 7) after comparing the target clearance value with the actual clearance value.

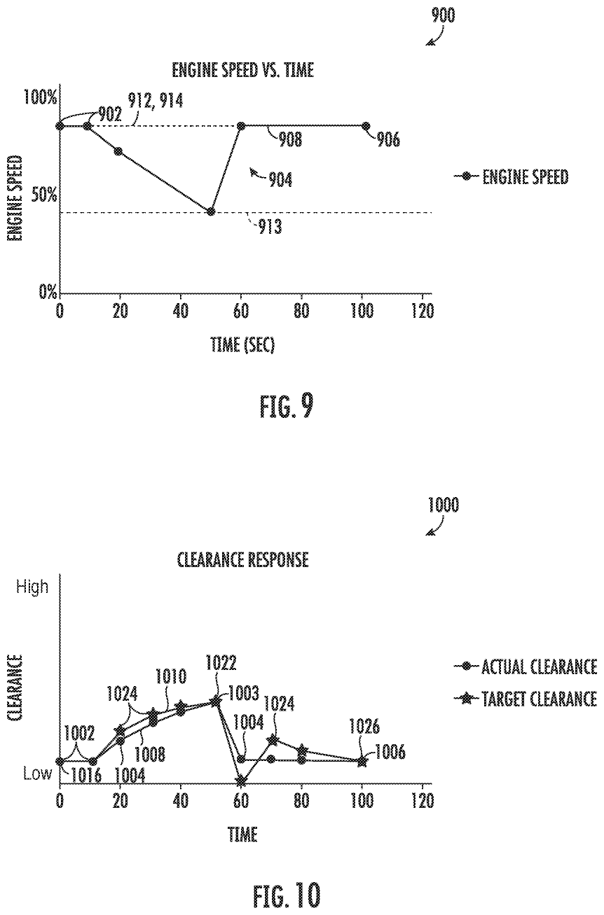

FIGS. 9 and 10 graphically depict the advantages and benefits of the control logic 600 described above with reference to FIG. 6. For example, FIG. 9 is a graph 900 of engine speed vs. time, in which time is plotted on the X-axis and engine speed is plotted on the Y-axis. The engine speed may be between 0% speed and 100% speed. The engine speed may be a rotational speed of the HP shaft 128 and/or the LP shaft 130. FIG. 10 is a clearance response graph 1000 of clearance vs. time, in which time is plotted on the X-axis and the clearance (e.g., between the blade tips 192a, 192b and the shrouds 190a, 190b) is plotted on the Y-axis. The clearance may be between a low or small clearance value (e.g., close to 0% where the tips of the rotor blades are close or contacting the casing) and a high or large clearance value (such that the tips of the rotor blades are far from the casing).

The graph 900 may include an engine speed line 908, which is representative of the rotational speed of the HP shaft 128 and/or the LP shaft 130 at the particular instances in time shown. By contrast, the clearance response graph 1000 may include an actual clearance line 1008 representative of the actual clearance (e.g., the measured, sensed, and/or calculated clearance at the particular instance in time) and a target clearance line 1010 representative of the target clearance (e.g., clearances generated by the engine controller 402 for optimal performance of the gas turbine engine 100). As shown in FIG. 10, the points of the actual clearance line 1008 are plotted with circles, and the points of the target clearance line 1010 are plotted with stars.

FIGS. 9 and 10 should be viewed collectively to appreciate the clearance response of the gas turbine engine 100 as a result of adjustments to the acceleration rate. For example, each of the graphs 900, 1000 share a common time X-axis from 0 to 120 seconds. As shown in FIGS. 9 and 10, the lines 908, 1008 may include initial points 902, 1002, which are associated with the first flight condition 912 (such as a steady state condition) of the gas turbine engine 100. For example, the initial points 902 may be the engine speed (e.g., the rotational speed of the HP shaft 128 and/or the LP shaft 130) in the first flight condition 912. Similarly, the initial points 1002 may be the actual clearance between the turbine blades and the shroud in the first flight condition 912. Additionally, as shown in FIGS. 9 and 10, the lines 908, 1008 may include final points 906, 1006, which are associated with a final flight condition 914. For example, the final points 906 may be the engine speed (e.g., the rotational speed of the HP shaft 128 and/or the LP shaft 130) in the final flight condition 914. Similarly, the final points 1006 may be the clearance between the turbine blades and the turbine casing in the final flight condition 914.

In the embodiment shown in FIGS. 9 and 10, the first flight condition 912 may be the same as the final flight condition 914. Further, as shown, the lines 908, 1008 may include an intermediate point 903, 1003 associated with an intermediate flight condition 913, which may be different than the first flight condition 912 and the final flight condition 914. For example, the intermediate points 903 may be the engine speed (e.g., the rotational speed of the HP shaft 128 and/or the LP shaft 130) in the intermediate flight condition 913. Similarly, the intermediate points 1003 may be the actual clearance between the turbine blades and the turbine casing in the intermediate flight condition 913.

Additionally, each of the lines 908, 1008 may include a plurality of transient points 904, 1004 between the initial points 902, 1002 and the intermediate point 903, 1003 and between the intermediate point 903, 1003 and the final points 906, 1006 as the gas turbine engine 100 transitions from the first flight condition 912 to the intermediate flight condition 913 and subsequently from the intermediate flight condition 913 to the final flight condition 914.

The intermediate flight condition 913 may require that the gas turbine engine decelerate (e.g., reduce the rotational speed of the HP shaft 128 and/or the LP shaft 130). Subsequently, the gas turbine engine 100 may be required to re-accelerate to the final flight condition 914. In doing so, the gas turbine engine 100 may encounter a hot rotor re-acceleration scenario. For example, during deceleration the casing cools and thermally retracts while the rotor (e.g., the shaft and the rotor disks) stays hot and thermally expanded due to the differences in mass between the casing and the rotor. As such, when the gas turbine engine re-accelerates (e.g., between the intermediate flight condition 913 and the final flight condition 914), the turbine blades have less room for mechanical expansion because the rotor is still hot and thermally expanded and the casing is cooled and thermally retracted.

The engine controller 402 may account for any hot rotor re-acceleration scenarios by linking the deceleration rate to transient target clearances. For example, the engine controller 402 may determine a plurality of transient target clearances 1024 between an initial target clearance 1016 and an intermediate target clearance 1022. When the gas turbine engine 100 is operating in a first flight condition 912 and a demand is received by the engine controller 402 for an intermediate flight condition 913 (e.g., a deceleration), the engine controller 402 may generate, determine, or set an intermediate target clearance 1022 associated with the intermediate flight condition 913 and a plurality of transient target clearances 1024 between the initial target clearance 1016 and the intermediate target clearance 1022. This advantageously allows for tighter clearances to be accomplished as the gas turbine engine transitions between the first flight condition and the second flight condition.

Similarly, when the gas turbine engine 100 is operating in the intermediate flight condition 913 and a demand is received by the engine controller 402 for a the final flight condition 914 (e.g., requiring a hot rotor re-acceleration of the gas turbine engine 100), the engine controller 402 may generate, determine, or set an a final target clearance 1026 associated with the final flight condition 914 without any transient target clearances between the intermediate target clearance 1022 and the final target clearance 1026. That is, the engine controller 402 may determine that a hot rotor re-acceleration is required, and may set the final target clearance 1026 without any transient target clearances, which advantageously allows the turbine blades with enough headroom or radial space to mechanically expand without causing a pinch or rub event with the casing.

As the gas turbine engine 100 is transitioning between the first flight condition 912 and the intermediate flight condition 913 and subsequently between the intermediate flight condition 913 and the final flight condition 914, the engine controller 402 may periodically (e.g., every 10 seconds as shown in FIGS. 9 and 10) compare the actual clearance line 1008 to the target clearance line 1010. If the actual clearance value is outside of a predetermined margin of the target clearance value at the particular point in time of the comparison, then the engine controller 402 may adjust the deceleration rate or acceleration rate of the gas turbine engine 100. For example, as shown in FIGS. 9 and 10 collectively, during the transitory state between the first flight condition 912 and the intermediate flight condition 914, the engine controller 402 may adjust the acceleration rate (as shown by the changing slope of the engine speed line 908 in FIG. 9) after comparing the target clearance value with the actual clearance value.

Additionally, or alternatively, the acceleration/deceleration rates may be adjusted based on other parameters, such as exhaust gas temperature, accelerometer data, strain measurements (e.g., via one or more strain gauge). For example, the acceleration may be adjusted based on the exhaust gas temperature (which may be measured with one or more sensors, or which may be calculated). Specifically, when the exhaust gas temperature exceeds a first predetermined value, or falls below a second predetermined value, the acceleration/deceleration may be adjusted. Similarly, if the gas turbine is experiencing excessive strain, then the acceleration/deceleration may be modified (e.g., the acceleration may be reduced).

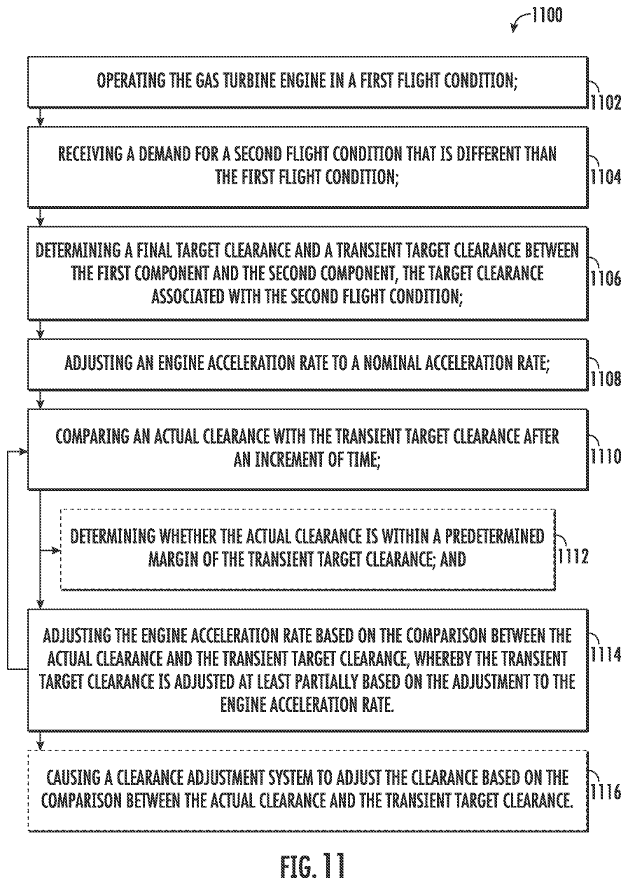

FIG. 11 provides a flow diagram for a method 1100 of operating a gas turbine engine (such as the gas turbine engine 100 discussed above). Some or all of the method 1100 can be implemented by the engine controller 402 (FIG. 4) described herein, for example. The gas turbine engine may include a first component (such as a casing 198) and a second component (such as a rotor blade 166) rotatable relative to the first component. A clearance is defined between (e.g., directly between) the first component and the second component.

In many implementations, the method may include at (1102) operating the gas turbine engine in a first flight condition. In exemplary implementations, the first flight condition may be a steady state cruise condition, in which the gas turbine engine is neither accelerating nor decelerating. For example, in a steady state cruise condition, the gas turbine engine (e.g., the HP shaft and/or the LP shaft) may be rotating at a generally constant speed. In other implementations, the first flight condition may be an accelerating condition in which the gas turbine engine is increasing speed. Alternatively, the first flight condition may be a decelerating condition in which the gas turbine engine is decreasing speed.

In various embodiments, the method 1100 may include at (1104) receiving a demand for a second flight condition that is different than the first flight condition. In exemplary embodiments, the second flight condition may be a step-climb condition. A step-climb condition occurs when the pilot of an aircraft elects to increase the altitude at which the aircraft is traveling. Altitude steps generally occur in 2,000 feet increments, as dictated by current FAA regulations. This means, for example, that the pilot of an aircraft flying at 33,000 feet may elect to undertake a step climb maneuver to cause the aircraft to climb 2,000 feet to an altitude of 35,000 feet. In order to effectuate the step climb, the pilot modifies the controls of an auto-pilot/auto-throttle system of the flight control system 420 to request that the aircraft ascend to the desired cruising altitude. The flight control system then uses predetermined algorithms to increase engine power in order to cause the aircraft to climb. The demand may be received by the engine controller by monitoring the position of a throttle and observing a particular change in the angle of the throttle, signifying a request for change in engine RPM or a step climb condition. The demand may also be received by the auto-pilot/auto-throttle control system of the flight control system, and the pilot may request an increase from one particular altitude to a second particular altitude. In response to that request, the flight control system sends a signal to the engine controller requesting increased engine power, which causes the gas turbine engine to accelerate.

In other embodiments, the second flight condition may be an accelerating condition in which the gas turbine engine is increasing speed. Alternatively, the second flight condition may be a decelerating condition in which the gas turbine engine is decreasing speed.

According to the exemplary embodiment of FIG. 11, engine control system 402 may receive a request for increased engine power and make a determination as to whether the aircraft is presently operating in a steady-state cruise condition. For example, to determine whether the aircraft is in a cruise condition, engine control system 402 may examine the following parameters: that the cruising altitude of the aircraft is greater than 29,000 feet; that the cruising altitude has not changed significantly over a predetermined period of time; that speed of the aircraft is relatively constant; and that the throttle position of the aircraft is not changing. In response to a determination that a cruise condition exists, engine control system 402 then interprets a request for increased engine power as a request for a step-climb condition.

In exemplary embodiments, the method 1100 may include at (1106) determining a final target clearance and a transient target clearance between the first component and the second component. The final target clearance may be associated with the second flight condition. That is, the final target clearance may be the optimized clearance when the gas turbine engine reaches the second flight condition. The transient target clearance may be generated by the engine controller, and the transient target clearance may be the optimized clearance for the gas turbine engine as the gas turbine engine is transitioning between the first flight condition and the second fight condition.

As shown in FIG. 11, in many implementations, the method 1100 may include at (1108) adjusting an engine acceleration rate to a nominal acceleration rate. The nominal acceleration rate maybe a predetermined acceleration rate that is initiated by the engine controller by default when the gas turbine engine is required to accelerate/decelerate. The nominal acceleration rate may be negative in implementations where the gas turbine engine is decelerating between the first flight condition and the second flight condition. The nominal acceleration rate may be an angular acceleration value (i.e., the change in the angular velocity, RPMs, per unit of time), such as revolutions per minute per second (e.g., RPM/s).

In exemplary implementations, the method 1100 may include at (1110) comparing (e.g., with an engine controller) an actual clearance with the transient target clearance after an increment of time. The actual clearance may be received and/or calculated by the engine controller. For example, in some implementations, the method may include receiving data indicating the actual clearance between the first component and a second component. The actual clearance being at least one of a measured clearance captured by a sensor and a calculated clearance specific to the gas turbine engine at that point in time. For example, the actual clearance may be indicated by a sensor and expressed in units of distance (such as millimeters).

In some implementations, comparing at (1110) may further include at (1112) determining whether the actual clearance is within a predetermined margin of the transient target clearance. The predetermined margin may be a ±15% margin of the transient target clearance, or such as a ±10% margin of the transient target clearance, or such as a ±5% margin of the transient target clearance, or such as a ±1% margin of the transient target clearance. The actual clearance is within the predetermined margin when the actual clearance neither exceeds a maximum margin threshold nor falls below a minimum margin threshold. Likewise, the actual clearance is outside the predetermined margin when the actual clearance either exceeds the maximum margin threshold or falls below a minimum margin threshold. For example, if the actual clearance is 1 mm, and the predetermined margin of the transient target clearance from 0.5 mm (minimum margin threshold) to 1.5 mm (maximum margin threshold), then the actual clearance is within the predetermined margin of the transient target clearance. By contrast, for example, if the actual clearance is 2 mm, and the predetermined margin of the transient target clearance from 0.5 mm (minimum margin threshold) to 1.5 mm (maximum margin threshold), then the actual clearance outside of within the predetermined margin of the transient target clearance. In such scenario, the actual clearance is too large, and the engine acceleration may be increased to cause more mechanical/thermal growth of the blades to reduce the actual clearance to be within the predetermined margin of the transient target clearance.

In certain embodiments, the method 1100 may include at (1114) adjusting the engine acceleration rate based on the comparison between the actual clearance and the transient target clearance. As a result, the transient target clearance may be adjusted at least partially based on the adjustment to the engine acceleration rate. For example, when the actual clearance is outside of the predetermined margin of the transient target clearance (e.g., either exceeds the maximum margin threshold or falls below a minimum margin threshold), then the engine acceleration rate may be adjusted (e.g., increased or decreased). For example, the engine acceleration rate may be increased/decreased by between about 1% and about 90%, or such as between about 1% and about 60%, or such as between about between about 1% and about 30%, or such as between about 1% and about 15%. Particularly, if the actual clearance exceeds the maximum margin threshold of the predetermined margin (i.e., the clearance is too big, which could result in inefficiencies), then the engine acceleration rate may be increased. By contrast, if the actual clearance falls below the minimum margin threshold of the predetermined margin (e.g., the clearance is too small, which may result in a pinch/rub event), then the engine acceleration rate may be decreased.

The transient target clearance may be adjusted in real time based on adjustments to other parameters of the gas turbine engine while the gas turbine engine is transitioning between the first flight condition and the second flight condition. Specifically, the transient target clearance may be adjusted each time the engine acceleration rate is adjusted. For example, if the acceleration rate of the gas turbine engine is adjusted based on the comparison between the actual clearance and the transient target clearance, then the transient target clearance may also be adjusted. In other words, the transient target clearance may be a function of engine speed (e.g., core speed or the rotational speed of the HP shaft and/or the LP shaft), such that as the gas turbine engine accelerates (or decelerates), the transient clearance targets will be adjusted based on the engine speed.

In some embodiments, the gas turbine engine includes a clearance adjustment system configured to adjust the clearance between the first component and the second component. In such embodiments, the method 1100 may include at (1116), which is an optional step as indicated by the box in phantom, causing the clearance adjustment system to adjust the clearance based the comparison between the actual clearance and the transient target clearance. For example, in addition to, or as an alternative to, adjusting the acceleration of the gas turbine engine, the clearance adjustment system may adjust (e.g., increase or decrease) when the actual clearance is outside of the predetermined margin of the transient target clearance (e.g., either exceeds the maximum margin threshold or falls below a minimum margin threshold).

In many embodiments, steps 1110 through 1114 may be repeated until the actual clearance is within a predetermined acceptable range of the final target clearance and/or when the actual clearance is equal to the final target clearance. Alternatively, or additionally, steps 1110 through 1114 may be repeated until the gas turbine engine has achieved (or is operating in) the second flight condition. For example, the method 1100 may include repeating the steps of comparing between the actual clearance and the transient target clearance and adjusting the engine acceleration rate based on the comparison after the increment of time until the actual clearance is within a predetermined acceptable range of the final target clearance. The predetermined acceptable range may be between about ±15% of the final target clearance, or such as about ±10% of the final target clearance, or such as about ±5% of the final target clearance, or such as about ±1% of the final target clearance.

In various embodiments, the method 1100 may include determining whether engine operating conditions allow for modification of the nominal acceleration rate. For example, the method 1100 may include determining whether or not the gas turbine engine operational conditions are flagged for an optimized acceleration rate (e.g., a deviation or modification from the nominal acceleration rate). Many operational conditions of the gas turbine engine may be flagged for the optimized acceleration rate, such as a most acceleration conditions (when the gas turbine engine is accelerating from a first speed to a second speed), step climb conditions, or others. However, some operational conditions, proceeding at the nominal acceleration rate may be optimal. For example, if the aircraft is in close proximity to the runway (such as takeoff or landing conditions). The engine controller may identify when operational conditions of the gas turbine engine are optimal for application of the optimized acceleration rate to ensure the optimized acceleration rates are not applied at inappropriate times. Optimized acceleration rates may refer to modifications from the nominal acceleration rate based on the comparison between the transient target clearances and the actual clearances.

FIG. 12 provides a block diagram of the engine controller 402 according to example embodiments of the present disclosure. As shown, the engine controller 402 can include one or more processor(s) 211 and one or more memory device(s) 212. The one or more processor(s) 211 can include any suitable processing device, such as a microprocessor, microcontroller, integrated circuit, logic device, and/or other suitable processing device. The one or more memory device(s) 212 can include one or more computer-executable or computer-readable media, including, but not limited to, non-transitory computer-readable media, RAM, ROM, hard drives, flash drives, and/or other memory devices.

The one or more memory device(s) 212 can store information accessible by the one or more processor(s) 211, including computer-readable or computer-executable instructions 213 that can be executed by the one or more processor(s) 211. The instructions 213 can include any set of instructions that, when executed by the one or more processor(s) 211, cause the one or more processor(s) 211 to perform operations. The instructions 213 can be software written in any suitable programming language or can be implemented in hardware. Additionally, and/or alternatively, the instructions 213 can be executed in logically and/or virtually separate threads on processor(s) 211. The memory device(s) 212 can further store data 214 that can be accessed by the processor(s) 211. For example, the data 214 can include models, lookup tables, databases, etc. The data 214 can include the sensor data 415 of FIG. 4.

The engine controller 402 can also include a network interface 215 used to communicate, for example, with the other devices communicatively coupled thereto (e.g., via a communication network). The network interface 215 can include any suitable components for interfacing with one or more network(s), including for example, transmitters, receivers, ports, controllers, antennas, and/or other suitable components. One or more devices can be configured to receive one or more commands, control signals, and/or data from the engine controller 402 or provide one or more commands, control signals, and/or data to the engine controller 402.

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The system and method disclosed herein facilitates the continuous linkage between the acceleration rate of the gas turbine engine and a target clearance, which advantageously prevents pinching of the rotor blades on one or more stationary components (such as the casing). At one or more points during an acceleration or deceleration, the system may determine whether the gas turbine engine is on pace to achieve a final target clearance, and the system may make adjustments to the acceleration/deceleration as necessary to reach the final clearance without causing a pinch event. This advantageously prolongs the life of the components gas turbine engine by preventing damage and allows for tighter clearances thereby increasing efficiency.

Further aspects are provided by the subject matter of the following clauses:

A gas turbine engine comprising: a first component; a second component rotatable relative to the first component, wherein a clearance is defined between the first component and the second component; and an engine controller having one or more processors, the one or more processors are configured to: operate the gas turbine engine in a first flight condition; receive a demand for a second flight condition that is different than the first flight condition; determine a final target clearance and a transient target clearance between the first component and the second component, the final target clearance associated with the second flight condition; adjust an engine acceleration rate to a nominal acceleration rate; compare an actual clearance with the transient target clearance after an increment of time; and adjust the engine acceleration rate based on the comparison between the actual clearance and the transient target clearance, wherein the transient target clearance is adjusted at least partially based on the adjustment to the engine acceleration rate.

The gas turbine engine of any preceding clause, wherein in comparing the actual clearance with the transient target clearance, one or more processors are further configured to: determine whether the actual clearance is within a predetermined margin of the transient target clearance; and adjust the engine acceleration rate when the actual clearance is not within the predetermined margin of the transient target clearance.

The gas turbine engine of any preceding clause, wherein in comparing the actual clearance with the transient target clearance, one or more processors are further configured to: determine that the actual clearance exceeds a predetermined margin of the transient target clearance; and increase the engine acceleration until the actual clearance is within the predetermined margin of the transient target clearance.

The gas turbine engine of any preceding clause, wherein in comparing the actual clearance with the transient target clearance, one or more processors are further configured to: determine that the actual clearance is less than a predetermined margin of the transient target clearance; and decrease the engine acceleration until the actual clearance is within the predetermined margin of the transient target clearance.

The gas turbine engine of any preceding clause, wherein the one or more processors are further configured to: repeat the comparison between the actual clearance and the transient target clearance and the adjustment of the engine acceleration rate based on the comparison after the increment of time until the actual clearance is within a predetermined acceptable range of the final target clearance.

The gas turbine engine of any preceding clause, wherein the one or more processors are further configured to: repeat the comparison between the actual clearance and the transient target clearance and the adjustment of the engine acceleration rate based on the comparison after the increment of time until the gas turbine engine is operating in the second flight condition.

The gas turbine engine of any preceding clause, wherein the one or more processors are further configured to: receive data indicating the actual clearance between the first component and a second component, the actual clearance being at least one of a measured clearance captured by a sensor and a calculated clearance specific to the gas turbine engine at that point in time.

The gas turbine engine of any preceding clause, further comprising a clearance adjustment system configured to adjust the clearance between the first component and the second component, and wherein the one or more processors are further configured to: cause the clearance adjustment system to adjust the clearance based the comparison between the actual clearance and the transient target clearance.

The gas turbine engine of any preceding clause, wherein the transient target clearance is adjusted each time the engine acceleration rate is adjusted.

The gas turbine engine of any preceding clause, wherein the one or more processors are further configured to: determine whether engine operating conditions allow for modification of the nominal acceleration rate.

The gas turbine engine of any preceding clause, wherein the first flight condition comprises a steady-state cruise condition, and wherein the second flight condition comprises a step-climb condition.

A non-transitory computer readable medium comprising computer-executable instructions, which, when executed by one or more processors of a computing system associated with a gas turbine engine, cause the one or more processors to: operate the gas turbine engine in a first flight condition; receive data indicating an actual clearance between a first component of the gas turbine engine and a second component of the gas turbine engine, the second component being rotatable relative to the first component, the actual clearance being at least one of a measured clearance captured by a sensor and a calculated clearance specific to the gas turbine engine at that point in time; receive a demand for a second flight condition that is different than the first flight condition; determine a final target clearance and a transient target clearance between the first component and the second component, the final target clearance associated with the second flight condition; adjust an engine acceleration rate to a nominal acceleration rate; compare the actual clearance with the transient target clearance after an increment of time; and adjust the engine acceleration rate based on the comparison between the actual clearance and the transient target clearance, wherein the transient target clearance is adjusted at least partially based on the adjustment to the engine acceleration rate.

The non-transitory computer readable medium of any preceding clause, wherein, in comparing the actual clearance with the transient target clearance, the one or more processors are configured to: determine whether the actual clearance is within a predetermined margin of the transient target clearance; and

adjust the engine acceleration rate when the actual clearance is not within the predetermined margin of the transient target clearance.

The non-transitory computer readable medium of any preceding clause, wherein the one or more processors are further configured to repeat the steps of: compare between the actual clearance and the transient target clearance; and adjust the engine acceleration rate based on the comparison after the increment of time until the actual clearance is within a predetermined acceptable range of the final target clearance.

The non-transitory computer readable medium of any preceding clause wherein the one or more processors are further configured to repeat the steps of: compare between the actual clearance and the transient target clearance; and adjust the engine acceleration rate based on the comparison after the increment of time until the gas turbine engine is operating in the second flight condition.

The non-transitory computer readable medium of any preceding clause, wherein the gas turbine engine includes a clearance adjustment system configured to adjust the clearance between the first component and the second component, and one or more processors are configured to: cause the clearance adjustment system to adjust the clearance based the comparison between the actual clearance and the transient target clearance.

The non-transitory computer readable medium of any preceding clause wherein the transient target clearance is adjusted each time the engine acceleration rate is adjusted.

The non-transitory computer readable medium of any preceding clause, wherein the one or more processors are further configured to: determine whether engine operating conditions allow for modification of the nominal acceleration rate.

The non-transitory computer readable medium of any preceding clause, wherein operating the gas turbine engine in a first flight condition comprises operating the gas turbine engine in a steady-state cruise condition, and wherein the second flight condition is a step-climb condition.

A method of operating a gas turbine engine, the gas turbine engine including a first component and a second component rotatable relative to the first component, a clearance being defined between the first component and the second component, the method comprising: operating the gas turbine engine in a first flight condition; receiving a demand for a second flight condition that is different than the first flight condition; determining a final target clearance and a transient target clearance between the first component and the second component, the final target clearance associated with the second flight condition; adjusting an engine acceleration rate to a nominal acceleration rate; comparing an actual clearance with the transient target clearance after an increment of time; and adjusting the engine acceleration rate based on the comparison between the actual clearance and the transient target clearance, wherein the transient target clearance is adjusted at least partially based on the adjustment to the engine acceleration rate.

The method of any preceding clause, wherein comparing the actual clearance with the transient target clearance further comprises: determining whether the actual clearance is within a predetermined margin of the transient target clearance; and adjusting the engine acceleration rate when the actual clearance is not within the predetermined margin of the transient target clearance.

The method of any preceding clause, further comprising repeating the steps of: comparing between the actual clearance and the transient target clearance; and adjusting the engine acceleration rate based on the comparison after the increment of time until the actual clearance is within a predetermined acceptable range of the final target clearance.

The method of any preceding clause, further comprising repeating the steps of: comparing between the actual clearance and the transient target clearance; and adjusting the engine acceleration rate based on the comparison after the increment of time until the gas turbine engine is operating in the second flight condition.

The method of any preceding clause, further comprising: receiving data indicating the actual clearance between the first component and a second component, the actual clearance being at least one of a measured clearance captured by a sensor and a calculated clearance specific to the gas turbine engine at that point in time.

The method of any preceding clause, wherein the gas turbine engine includes a clearance adjustment system configured to adjust the clearance between the first component and the second component, and wherein the method further comprises: causing the clearance adjustment system to adjust the clearance based the comparison between the actual clearance and the transient target clearance.

The method of any preceding clause, wherein the transient target clearance is adjusted each time the engine acceleration rate is adjusted.

The method of any preceding clause, further comprising: determining whether engine operating conditions allow for modification of the nominal acceleration rate.

The method of any preceding clause, wherein operating the gas turbine engine in a first flight condition comprises operating the gas turbine engine in a steady-state cruise condition, and wherein the second flight condition is a step-climb condition.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A gas turbine engine comprising:
a first component;
a second component rotatable relative to the first component, wherein a clearance is defined between the first component and the second component; and
an engine controller having one or more processors, the one or more processors are configured to:
operate the gas turbine engine in a first flight condition;
receive a demand for a second flight condition that is different than the first flight condition;
determine a final target clearance and a transient target clearance between the first component and the second component, the final target clearance associated with the second flight condition;
adjust an engine acceleration rate to a nominal acceleration rate;
compare an actual clearance with the transient target clearance after an increment of time;
adjust the engine acceleration rate based on the comparison between the actual clearance and the transient target clearance, wherein the transient target clearance is adjusted at least partially based on the adjustment to the engine acceleration rate, wherein adjusting the transient target clearance at least partially based on the adjustment to the engine acceleration rate is continuous;
determine whether the actual clearance is consistent with the transient target clearance; and
adjust or maintain the acceleration rate based on determining whether the actual clearance is consistent with the transient target clearance to achieve the transient target clearance.

2. The gas turbine engine of claim 1, wherein in comparing the actual clearance with the transient target clearance, one or more processors are further configured to:
determine whether the actual clearance is within a predetermined margin of the transient target clearance; and
adjust the engine acceleration rate when the actual clearance is not within the predetermined margin of the transient target clearance.

3. The gas turbine engine of claim 1, wherein in comparing the actual clearance with the transient target clearance, the one or more processors are further configured to:
determine that the actual clearance exceeds a predetermined margin of the transient target clearance; and
increase the engine acceleration rate until the actual clearance is within the predetermined margin of the transient target clearance.

4. The gas turbine engine of claim 1, wherein in comparing the actual clearance with the transient target clearance, the one or more processors are further configured to:
determine that the actual clearance is less than a predetermined margin of the transient target clearance; and
decrease the engine acceleration rate until the actual clearance is within the predetermined margin of the transient target clearance.

5. The gas turbine engine of claim 1, wherein the one or more processors are further configured to:
repeat the comparison between the actual clearance and the transient target clearance and the adjustment of the engine acceleration rate based on the comparison after the increment of time until the actual clearance is within a predetermined acceptable range of the final target clearance.

6. The gas turbine engine of claim 1, wherein the one or more processors are further configured to:
repeat the comparison between the actual clearance and the transient target clearance and the adjustment of the engine acceleration rate based on the comparison after the increment of time until the gas turbine engine is operating in the second flight condition.

7. The gas turbine engine of claim 1, wherein the one or more processors are further configured to:
receive data indicating the actual clearance between the first component and the second component, the actual clearance being at least one of a measured clearance captured by a sensor and a calculated clearance specific to the gas turbine engine at that point in time.

8. The gas turbine engine of claim 1, further comprising a clearance adjustment system configured to adjust the clearance between the first component and the second component, and wherein the one or more processors are further configured to:
cause the clearance adjustment system to adjust the clearance based the comparison between the actual clearance and the transient target clearance.

9. The gas turbine engine of claim 1, wherein the transient target clearance is adjusted each time the engine acceleration rate is adjusted.

10. The gas turbine engine of claim 1, wherein the one or more processors are further configured to:
determine whether engine operating conditions allow for modification of the nominal acceleration rate.

11. The gas turbine engine of claim 1, wherein the first flight condition comprises a steady-state cruise condition, and wherein the second flight condition comprises a step-climb condition.

12. A non-transitory computer readable medium comprising computer-executable instructions, which, when executed by one or more processors of a computing system associated with a gas turbine engine, cause the one or more processors to:
operate the gas turbine engine in a first flight condition;
receive data indicating an actual clearance between a first component of the gas turbine engine and a second component of the gas turbine engine, the second component being rotatable relative to the first component, the actual clearance being at least one of a measured clearance captured by a sensor and a calculated clearance specific to the gas turbine engine at that point in time;
receive a demand for a second flight condition that is different than the first flight condition;
determine a final target clearance and a transient target clearance between the first component and the second component, the final target clearance associated with the second flight condition;
adjust an engine acceleration rate to a nominal acceleration rate;
compare the actual clearance with the transient target clearance after an increment of time;
adjust the engine acceleration rate based on the comparison between the actual clearance and the transient target clearance, wherein the transient target clearance is adjusted at least partially based on the adjustment to the engine acceleration rate, wherein adjusting the transient target clearance at least partially based on the adjustment to the engine acceleration rate is continuous;
determine whether the actual clearance is consistent with the transient target clearance; and
adjust or maintain the acceleration rate based on determining whether the actual clearance is consistent with the transient target clearance to achieve the transient target clearance.

13. The non-transitory computer readable medium of claim 12, wherein, in comparing the actual clearance with the transient target clearance, the one or more processors are configured to:
determine whether the actual clearance is within a predetermined margin of the transient target clearance; and
adjust the engine acceleration rate when the actual clearance is not within the predetermined margin of the transient target clearance.

14. The non-transitory computer readable medium of claim 12, wherein the one or more processors are further configured to repeat the steps of:
compare between the actual clearance and the transient target clearance; and
adjust the engine acceleration rate based on the comparison after the increment of time until the actual clearance is within a predetermined acceptable range of the final target clearance.

15. The non-transitory computer readable medium of claim 12, wherein the one or more processors are further configured to repeat the steps of:
compare between the actual clearance and the transient target clearance; and
adjust the engine acceleration rate based on the comparison after the increment of time until the gas turbine engine is operating in the second flight condition.

16. The non-transitory computer readable medium of claim 12, wherein the gas turbine engine includes a clearance adjustment system configured to adjust the actual clearance between the first component and the second component, and the one or more processors are configured to:
cause the clearance adjustment system to adjust the clearance based the comparison between the actual clearance and the transient target clearance.

17. The non-transitory computer readable medium of claim 12, wherein the transient target clearance is adjusted each time the engine acceleration rate is adjusted.

18. The non-transitory computer readable medium of claim 12, wherein the one or more processors are further configured to:
determine whether engine operating conditions allow for modification of the nominal acceleration rate.

19. (canceled)

20. A method of operating a gas turbine engine, the gas turbine engine including a first component and a second component rotatable relative to the first component, a clearance being defined between the first component and the second component, the method comprising:
operating the gas turbine engine in a first flight condition;
receiving a demand for a second flight condition that is different than the first flight condition;
determining a final target clearance and a transient target clearance between the first component and the second component, the final target clearance associated with the second flight condition;
adjusting an engine acceleration rate to a nominal acceleration rate;
comparing an actual clearance with the transient target clearance after an increment of time;
adjusting the engine acceleration rate based on the comparison between the actual clearance and the transient target clearance, wherein the transient target clearance is adjusted at least partially based on the adjustment to the engine acceleration rate, wherein adjusting the transient target clearance at least partially based on the adjustment to the engine acceleration rate involves increasing the engine acceleration rate;
determining whether the actual clearance is consistent with the transient target clearance; and
adjusting or maintaining the acceleration rate based on determining whether the actual clearance is consistent with the transient target clearance to achieve the transient target clearance.

21. The gas turbine engine of claim 1, wherein the one or more processors are further configured to:
determine an initial target clearance associated with the first flight condition and the final target clearance associated with the second flight condition;
determine a plurality of transient target clearances associated with a transition between the first flight condition and the second flight condition, the plurality of transient target clearances disposed between the initial target clearance and the final target clearance; and
while transitioning between the first flight condition and the second flight condition:
determine whether the actual clearance is consistent with the plurality of transient target clearances; and
adjust or maintain the acceleration rate based on determining whether the actual clearance is consistent with the plurality of transient target clearances to achieve the plurality of transient target clearances.
